(19) United States
(12) Patent Application Publication
(10) Pub. No.: US 2006/0210739 A1
(43) Pub. Date: Sep. 21, 2006

(54) Container with acid diffusion barrier and use thereof

(76) Inventors: Markus Loffler, Hechingen-Boll (DE); Reinhold Deppisch, Hechingen (DE); Ernst Luppold, Hechingen (DE); Patrik Dalholm, Lund (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/534,227

(22) PCT Filed: Nov. 7, 2003
(86) PCT No.: PCT/SE03/01730

§ 371 Date: Apr. 27, 2006

(30) Foreign Application Priority Data
Nov. 8, 2002 (SE) 0203313-2

(51) Int. Cl. B32B 27/08

(52) U.S. Cl. 428/35.7

(57) ABSTRACT

The invention relates to a container having a wall structure comprising a polymer material including an acid diffusion barrier. The invention also relates to a use of a cycloolefin polymer, COP, and/or a cycloolefin copolymer, COC, as an acid diffusion barrier polymer in a container for an acid. The invention further relates to a use of such a container and to a system for providing a medical solution comprising at least one container according to the invention. Finally the invention relates to a method for treatment by means of a container according to the invention.

### TECHNICAL FIELD OF THE INVENTION

The present invention relates to a container having a wall structure comprising a polymer material including an acid diffusion barrier.

The invention also relates to a use of a cycloolefin polymer, COP, and/or a cycloolefin copolymer, COC, as an acid diffusion barrier polymer in a container for an acid.

The invention further relates to a use of such a container and to a system for providing a medical solution comprising at least one container according to the invention.

Finally the invention relates to a method for treatment by means of a container according to the invention.

### BACKGROUND OF THE INVENTION

Containers for accommodation of an acid in fluid or in powder form are employed in many different applications within the chemical, technological, medical, pharmaceutical and food field, among others. One application is within the medical field where polymer containers for containing an acid are used. The container may e g be a supply bag for a medical purpose where the container contains an acid fluid in, or for the preparation of, a resulting sterile or non-sterile medical solution. For example, the acid fluid may be used in a dialysis fluid for buffering causes in order to take care of toxic substances in a patient that suffers from a kidney disease. Such a dialysis fluid is for example intended for hemodialysis, hemodiafiltration, hemofiltration, peritoneal dialysis, intensive care fluid management, nutrition compounds, concentrates, lavage fluids or infusion therapies. The acid serves to balance the pH-value of a fluid so that the resulting medical solution has a physiological pH that is substantially neutral, i e a pH value between 6.5 and 8, preferably between 7.0 and 7.4.

As the acid in the container diffuses through the wall structure to the outside of the container over time, it is necessary to secure an allowable permeation by diffusion through the wall of the container. Diffusion in excess of certain limits will adversely affect the composition of the resulting solution. It is especially important to control diffusion in medical solutions, as an unacceptable change in pH and in concentrations of electrolytes and glucose will negatively affect the patient. Examples of acids used in medical solutions are acetic, citric, gluconic, lactic, carbonic and hydrochloric acids, etc.

If the acid is of the bad smelling type, as for example acetic acid, a disadvantageous effect of diffusion is that an odour is connected to the container. A further disadvantage is the risk that materials that come in contact with the container may corrode and degradation products may enter into the fluid and cause deleterious effects. It is especially important that the diffusion of the acid through the wall of the container is limited in cases where the container needs to be stored while containing the acid to avoid change in composition.

Containers within the prior art intended for containing acid are normally made of a polymer film. However, all polymer materials are not suitable for the purpose of containing an acid as interaction with highly concentrated acid may result in extraction of toxic additives or polymeric components from the polymer material, which may cause problems when the acid is used. Prior art containers are for example single or multilayer flexible, semirigid or rigid containers made of polyolefin (polypropylene, PP, or polyethylene, PE), polyamide, PA, ethylene vinyl acetate, EVA, and/or ethylene vinyl alcohol, EVOH. The film may be a single-layer film, which for example is extruded, or a multi-layer film, which for example is coextruded or laminated. The prior art containers having walls made of these polymer films ensure general chemical resistance and low water uptake but have the disadvantage that the velocity of diffusion of acid through the wall is high and not acceptable when the acid concentration in the container is increased. To overcome this drawback the acid is diluted to such an extent that the velocity of diffusion is acceptable over time. However, dilution of the acid results in that the amount of acid fluid is larger than actually needed as well as the container. A known container of Gambro AB, SelectBag™, for acid fluid have for example an acid concentration of 7%. This acid fluid is then mixed with further substances and diluted 400 times by a defined dilution operation before used in a dialysis machine for dialysis treatment of a patient.

An alternative way to overcome the drawback with increased diffusion velocity, when the concentration of acid is increased in the polymer container, is to provide containers with increased wall thickness. Increased wall thickness, however, results in increased weight, production and transportation costs, consumption of materials and environmental impact. Further, an increased wall thickness involves reduced flexibility of the container.

Normally, when high concentrations of acid are to be stored, glass bottles or bottles that provide an acceptable barrier against diffusion of acid are used. Glass bottles though, are heavy and unpractical to handle and expensive to manufacture and transport.

It is highly desirable to use highly concentrated acids and other dialysis components in order to refine and improve dialysis procedure, for example individualizing dialysis treatment and creating logistic advantages by lower fluid volumes.

### SUMMARY OF THE INVENTION

The object of the present invention is to provide a container for an acid, wherein the above-mentioned drawbacks have been eliminated or alleviated.

According to the present invention this object has been achieved by a container having a wall structure comprising a polymer material, characterized in that the polymer material includes an acid diffusion barrier comprising a cycloolefin polymer, COP, and/or a cycloolefin copolymer, COC, and that the container contains an acid. Preferred embodiments of the container are set forth in the enclosed dependent claims 2-19 and in the following description.

Another object of the invention is to provide a use of a cycloolefin polymer, COP, and/or a cycloolefin copolymer, COC, as an acid diffusion barrier polymer in a container for an acid.

A further object is to provide a use of the container of the invention for storing a medical solution for hemodialysis, hemodiafiltration, hemofiltration, peritoneal dialysis, intensive care fluid management, nutrition compounds, concentrates, lavage fluids or for infusion therapies.

Yet another object is to achieve a system providing a medical solution comprising at least one container according to the invention. Preferred embodiments of the system are set forth in the enclosed dependent claims 23 and 24 and in the following description.

Finally, an object of the present invention is to provide a method for treatment by hemodialysis, hemodiafiltration, hemofiltration, peritoneal dialysis, intensive care fluid management, nutrition compounds, concentrates, lavage fluids or infusion therapies by means of a container according to any of claims 1-19.

By the invention a container is achieved which has a decreased permeability of acid compared to prior art and thereby a decreased diffusion of acid so that the diffusion of acid is acceptable over time.

Another advantage is that the concentration of acid may be chosen in the whole range of 0-100%. This means that highly concentrated acid may be contained in the container. By utilizing less diluted acid a smaller container is required, which means decreased weight, production and transportation costs, consumption of material and environmental effect. Alternatively the amount of acid is increased while keeping the same size of the bag so as to provide a container for an acid containing medical solution where the medical solution lasts for longer treatments.

A further advantage of the invention is that the wall thickness may be kept small so that a convenient flexibility of the container may be chosen.

Yet another advantage is that a less loss of acid increases the time possible to store the acid-containing container, i e increased shelf life is achieved.

Another advantage is that the container may be provided with an innermost COC containing layer in order to have this innermost layer protecting other layers which may have functions for sealing or permeability of other solvents than acid.

Other objects, features, advantages and preferred embodiments of the present invention will become apparent from the following detailed description when taken in conjunction with the drawings and the appended claims.

### BRIEF DESCRIPTION OF THE DRAWINGS

Preferred embodiments of the present invention will now be described in more detail, reference being made to the enclosed drawings, in which:

FIG. 1 shows an embodiment of a supply bag according to the present invention, and

FIG. 2 illustrates a system including the supply bag in FIG. 1 for providing a medical solution.

### DETAILED DESCRIPTION OF PREFERRED EMBODIMENTS

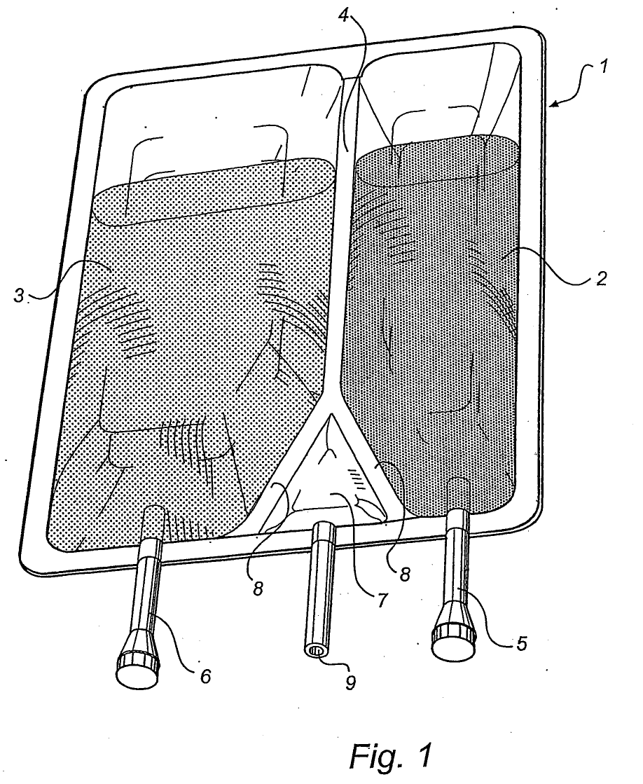

In FIG. 1 is shown a container 1 with a wall structure comprising a barrier polymer, the container 1 being suitable for containing an acid. More specifically, FIG. 1 discloses a container 1 in the form of a supply bag for a medical fluid. The supply bag is provided with two compartments 2, 3 for concentrates, i e one compartment 2 for an acid and minor electrolytes, e g Ca²⁺ and Mg²⁺, and one compartment 3 for a carbohydrate containing concentrate, such as a glucose or a glucose like concentrate and minor electrolytes, e g K⁺. It is known that in a solution containing an acid and further substances, certain chemical reactions, during certain circumstances, takes place resulting in decomposition of the substances giving an increased pH value in the resulting solution. For this reason, at least in the medical field, it is advisable to arrange the acid fluid separately from such substances. The acid may be arranged in a separate container or compartment of a container in order to keep the acid separated from other substances.

The acid and the glucose or glucose like concentrate does not form a stable solution if they are mixed and then stored. Therefore the two concentrates are kept separated until shortly before use in a patient. The acid may be an organic or an inorganic acid. In case the acid is used in a medical solution it is biocompatible and metabolisable. More specifically, the acid is for example acetic acid, hydrochloric acid, gluconic acid, lactic acid, carbonic acid or citric acid, etc. Further, the acid may be a concentrate for a dialysis fluid.

The acid may be diluted in a fluid that also contains ions such as sodium, calcium or magnesium for preparation of the medical solution. The compartments 2, 3 are separated by means of a first openable seal 4 in the form of a first peel seal 4 during storage and transportation. Shortly before use of the medical solution the first peel seal 4 is opened and the concentrates from the respective compartment 2, 3 are mixed. The respective concentrate compartment is provided with an inlet 5, 6 for filling the glucose and the acid fluid into the respective compartment 2, 3. The supply bag 1 further comprises a third compartment 7 which is separated from the acid compartment 2 and the glucose compartment 3 via a second openable seal 8 in the form of a second peel seal 8. An outlet 9 from the supply bag 1 is arranged to the third compartment 7 which is substantially empty.

In a not shown, alternative supply bag, the two compartments containing the two concentrates respectively are separated by means of a seal. Breakable connectors are arranged between the two compartments and a third compartment. Shortly before use, the connectors are broken and the fluid concentrates are mixed in the third compartment.

A characterizing feature of the container of the present invention is that the container polymer material includes an acid diffusion barrier comprising a cycloolefin polymer, COP, and/or a cycloolefin copolymer, COC, and that the container contains an acid.

In a preferred embodiment of the present invention the cycloolefin polymer or the cycloolefin copolymer has a water vapour permeability below 0.05 g·mm/m²·day, when tested according to DIN 53 122 at 23° C.

In yet another preferred embodiment the cycloolefin polymer or the cycloolefin copolymer has a water uptake below 0.01%, when tested according to ISO 621 at 23° C.

According to an advantageous embodiment the cycloolefin polymer or the cycloolefin copolymer has an acetic acid permeability below 0.02 ml/m²·day, preferably below 0.007 ml/m²·day, when tested according to ISO/CD 15105-2 (Plastics—Film and sheeting—Determination of gas transmission rate—Instrument method—Part 2: Equal pressure method).

An example of a polymer material film for a container according to the invention comprises a first inner layer containing PP or PE or a mixture thereof, a second layer of COC, a third, fourth and a fifth layer of PE and an outer layer of PA. The COP and/or COC is incorporated into the wall structure either as pure granules or as granulated concentrate by premixing for example polyolefin granules or powder with the COP or the COC or both.

The bag 1 shown in FIG. 1, e g includes acetic acid in an amount of 150 ml having a concentration of 22% suitable for a dialysis solution. Such a bag is a third of the size of a bag known in the prior art and contains an acid fluid with 3 times higher concentration. The inventive bag may be stored over a period of for example 1 year, as the diffusion of acid over that period of time is within acceptable limits.

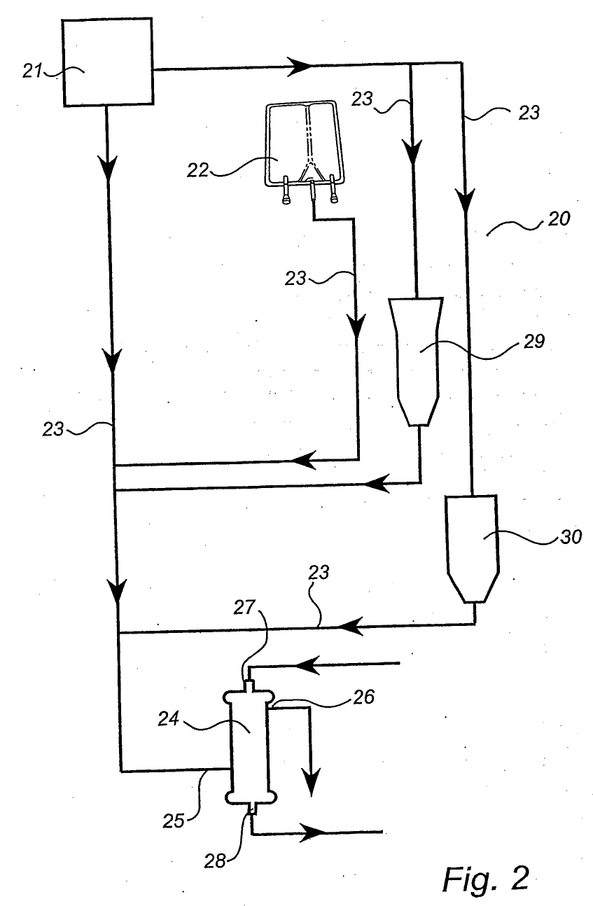

In FIG. 2 is shown a system 20 for preparing a fluid intended for a medical procedure substantially at the time of use by diluting the acid with water. The system comprises a reservoir 21 for a source of the water, at least one supply bag 22 of the type disclosed in FIG. 1, a fluid circuit 23 for conducting the fluid and a dialyser 24. The mixed concentrate are withdrawn from the supply bag 22 to the fluid circuit 23 and water is withdrawn from the reservoir 21 to the fluid circuit 23 in a predetermined ratio in order to provide a duly diluted medical solution to the dialyser 24 via inlet 25. The used medical solution leaves the dialyser 24 via outlet 26. Blood from a not shown patient to be dialyzed is let in to the dialyser 24 via inlet 27 and received by the patient via outlet 28. The system further includes one or more supply bags and/or containers 29,30 where each container/bag 29, 30 includes one or more substances to be dissolved in the resulting medical solution, such as electrolytes. By a reservoir for a source of water is intended a reservoir or an in-line water plant.

The acid and glucose may be in fluid form. Alternatively the acid and/or the glucose is in powder or granular form intended to be dissolved in water and then diluted. Such dissolution may take place in a separate process so that all of the powder is dissolved before dilution. The dissolution may also take place on-line by passing water through a bed of powder in order to produce a solution to then be diluted. The powder may be a single component or a mixture of components.

It is conventional in hemodialysis to prepare the solution in situ by mixing one ore more concentrates with water in a dialysis machine. The acid concentrate is kept separated from the rest of the components in the medical solution until shortly before use. The resultant medical solution after mixing is substantially neutral, for example with pH value between 6.5 and 8.0, preferably between 7.0 and 7.4. The dialysis machine controls the mixing so that the correct composition of the prepared dialysis solution is attained.

Preferably the barrier polymer comprises a cycloolefin copolymer, COC. The COC may be a reaction product of alkylene and norbonene using metallocene catalyst technology to form statistically distributed amorphous copolymers based on cycloolefins and linear olefins: 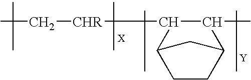
wherein R is H or a linear olefine, and X and Y are integers ≧1.

An example of a preferred COC is Topas® provided by Ticona GmbH, especially the available Topas® grades 5013, 6013, 6015, 6017 or 8007.

The barrier may be arranged as at least one layer in the wall structure. Any further layer in the wall structure is preferably of a polyolefin such as polyethylene, E, polypropylene, PP, polyamide, PA, ethylene vinyl acetate, EVA, and/or ethylene vinyl alcohol, EVOH, etc. Any further layer may as well be a mixture of any of the mentioned materials.

In a preferred embodiment of the invention the acid diffusion barrier polymer at least is provided as an innermost layer of the container in contact with the contained acid. In yet another preferred embodiment the acid diffusion barrier polymer is provided as a layer on the inner side of a polymer layer comprising a polymer having a high water uptake, e g EVOH. By this arrangement of the layers the barrier polymer material protects an EVOH containing layer from water uptake which would be detrimental to the gas barrier properties of EVOH.

In an advantageous embodiment of the invention the first inner layer includes PP or PE or a mixture thereof, a second layer includes COC, a third, fourth and a fifth layers include PE and an outer layer includes PA.

The wall structure may be produced as a laminated foil. Alternatively the wall structure as well as the barrier is produced from a granular state and extruded or coextruded into a foil. The extruded or coextruded foil may in its turn be laminated with further layers or foils. An advantage with coextrusion is that any difficulties with delaminating within the foil as such are decreased. Alternatively the material is moulded or blow formed.

Films containing COC are known for providing a barrier against the passage of water vapour and for providing acceptable chemical resistance against acid. By barrier properties is herein meant low diffusion and low permeability of gases and liquids. By chemical resistance is intended low reactivity, swelling and solubility of the polymer material with chemicals.

Further, COC is known for having good transparency and for having low water absorption. When using COC for medical purposes it is its low content of extractables due to the manufacturing technology using metallocene catalysts and the favourable processing properties, e g low melt flow index for easy processing to foils or injecting moulding parts, that is appreciated. Films containing COC are for example used for medical packaging such as blister packages.

The fact that prior art containers for the accommodation of acid fluids made of polyolefins, such as PE or PP, exhibit water permeabilities and chemical resistance against acid within approximately the same range as COC, makes it a completely unexpected result, that films containing COC provide a barrier against the passage of acid. Especially, a film containing COC has shown a substantially increased barrier against diffusion of acetic acid in comparison with a known film without any barrier of COC. In fact the result is 10 to 100 times better than what is achieved by prior art materials.

The present invention will now be illustrated by way of non-limiting examples of preferred embodiments in order to further facilitate the understanding of the invention. In the examples below, the duffusion rate for acetic acid was measured according to the following method:

The principle of the method is the isostatic carrier gas method, i e both sides of a test film have the same absolute pressure. The driving force for the diffusion is the partial pressure of the acetic acid, which is kept low on the carrier gas side of the test film.

The test film is stretched and tightened between two chambers. The temperature was set to the test temperature (40° C.) in the two chambers. The diffusion surface was 50 cm², The acetic acid was distributed on the diffusion surface and would in the ideal case reach the other side of the test film by solution diffusion. On the other side the clean barrier gas will remove the penetrating molecules. The amount of penetrated molecules is measured with gas chromatography (GC) with a flame ionization detector (FID). The GC is calibrated on the acetic acid.

The process of the diffusion measurement could be divided into three phases:
1. Break through time: This is the time until the first molecule has penetrated through the test film.
2. Increasing curve: The measured signal is increasing with time.
3. Stationary phase: The measured signal is the same and is no longer changing.

The results presented in the tables are for the stationary phase and are given in ml/(m²*day). This set up corresponds to a not, as of today, published Norm test ISO/CD 15105-2 (Plastics—Film and sheeting—Determination of gas transmission rate—Instrument method—Part 2: Equal pressure method).

### EXAMPLES

In table 1 below is shown the tests results of polymer films made of polyethylene, PE, polypropylene, PP, as well as multilayer films comprising a barrier polymer in the form of single layer of cyclopolyolefin copolymer, COC. The tested COC was TOPAS®. The concentration of the acetic acid used in the test was 22%. The films were tested for a period of 5 days but the film containing PP and COC was tested for a period of 33 days. Under the test conditions the temperature was 40° C. in ambient air. For example, it is shown that the diffusion velocity through a foil of a PE material without any COC barrier amounts to 0.88 ml/m²·day. This result can be compared to the diffusion velocity through a PE and COC containing film, which only amounts to 0.007 ml/m²·day, i e only 0.8% of the result for PE without any COC. Correspondingly, the diffusion velocity through a PP and COC containing film is below 0.02 ml/m²·day, which may be compared to the diffusion velocity through a foil of a PP material without any COC barrier, which amounts to 0.20 ml/m²·day, i e the result for PP with a COC barrier is only 10% of the result for PP material without COC barrier. These results confirm a substantial improvement when using certain polyolefins such as COC as a barrier in comparison with prior art using materials comprising PP or PE without any COC barrier. The test confirms that in comparison to PP and PE-foils, respectively, COC-containing films or bags has an extremely low diffusion rate for acetic acid. In fact the result is 10 to 100 times better than what was achieved by prior art materials.

TABLE 1

| | | | Diffusion |
|---|---|---|---|
| | | Diffusion | rate |
| | Thickness | rate | (ml/m² · day/ |
| Material | (μm) | (ml/m² · day) | 100 μm) * |
| Multi layer | 209 | 0.20 | 0.096 |
| film of PP | | | |
| Single layer | 103 | 0.88 | 0.854 |
| film of PE | | | |
| Bag of PP and | 195 | ≦0.02 | ≦0.01 |
| COC, double | | after 33 | after 33 |
| layer PP and | | days | days |
| single layer | | | |
| COC | | | |
| Double layer | 85 | 0.007 | 0.0082 |
| foil of PE and | | | |
| single layer | | | |
| of COC | | | |

* recalculated into 100 μm film thickness.

In another test a container having a polymer film wall thickness of 90 μm comprising a first and a third 35 μm layer of a polyolefin, a second 20 μm layer of COC between the first and the third layer, was tested. The container contained acetic acid in a concentration of 22% and the surrounding temperature was 40° C. In this test the loss of acid over a period of 60 days was 0.5% which is remarkably little. In a corresponding test of a container having an increased COC layer, i e a COC layer of 30 μm showed only a slightly less loss of acid.

### Example 2

The material in the wall structure of the inventive container may alternatively be characterized by its water uptake and water permeability. It has been found that COC-containing foils having water a permeability below 0.05 g˜mm/m²·day while tested according to DIN 53 122 at 23° C. and 85% relative humidity, have a suitably low permeability for acetic acid.

TABLE 2

| | Water | Water vapour | | |
|---|---|---|---|---|
| | uptake | permeability | | Acetic acid |
| | (%) acc | (g · mm/m² · day) | Acetic acid | permeability |
| | to ISO | acc to DIN | permeability | (ml/m² · day) |
| Material | 62 | 53122 | (ml/m² · day) | 100 μm) |
| PP | <0.01 | 0.08 | 0.2 | 0.096 |
| (209 μm) | | | | |
| PE/COC | <0.01 | 0.025-0.05 | <0.007 | 0.0082 |
| PE | <0.01 | 0.035-0.07 | 0.88 | 0.854 |
| (103 μm) | | | | |

It will be readily apparent to one skilled in the art that various substitutions and modifications may be made to the invention disclosed herein without departing from the scope and spirit of the invention.

1. A container having a wall structure comprising a at least one polymer material, wherein the polymer material comprises an acid diffusion barrier comprising at least one polymer chosen from a cycloolefin polymer, and a cycloolefin copolymer, COC, and wherein the container contains an acid.

2. A container according to claim 1, wherein the cycloolefin polymer or the cycloolefin copolymer has a water vapour permeability below 0.05 g·mm/m²·day, when tested according to DIN 53 122 at 23° C.

3. A container according to claim 1, wherein the cycloolefin polymer or the cycloolefin copolymer has a water uptake below 0.01%, when tested according to ISO 621 at 23° C.

4. A container according to claim 1, wherein the cycloolefin polymer or the cycloolefin copolymer has an acetic acid permeability below 0.02 ml/m²·day, when tested according to ISO/CD 15105-2.

5. A container according to claim 1, wherein said acid is chosen from of acetic acid, hydrochloric acid, gluconic acid, lactic acid, carbonic acid, and citric acid.

6. A container according to claim 1, wherein the acid is an acidic liquid.

7. A container according to claim 1, wherein the acid is a concentrate for a dialysis fluid.

8. A container according to claim 1, wherein the polymer material comprises a cycloolefin copolymer, and the cycloolefin copolymer is an amorphous copolymer.

9. A container according to claim 8, wherein the cycloolefin copolymer is based on cycloolefins and linear olefins.

10. A container according to claim 1, wherein the polymer of the acid diffusion barrier is processed in a multilayer arrangement with at least one polymer chosen from PP, PE, PA, EVA and EVOH.

11. A container according to claim 10, wherein the polymer of the acid diffusion barrier is at least provided as an inner layer in contact with the contained acid.

12. A container according to claim 10, wherein the polymer of the acid diffusion barrier is provided as a layer on the inner side of a polymer layer comprising a polymer having a high water uptake.

13. A container according to claim 12, wherein said polymer having a high water uptake is EVOH.

14. A container according to claim 10, wherein a first inner layer comprises PP or PE or a mixture thereof, a second layer comprises of cycloolefin copolymer, a third, fourth and a fifth layers include comprises PE and an outer layer comprises PA.

15. A container according to claim 1, wherein the wall structure is made of a coextruded film.

16. A container according to claim 1, wherein at least a first and a second compartment are provided within said container.

17. A container according to claim 16, wherein said compartments are separated by an openable seal provided between the compartments.

18. A container according to claim 16, wherein the first compartment comprises the acid and the second compartment comprises a carbohydrate containing fluid.

19. A container according to claim 18, wherein the carbohydrate containing fluid is a glucose fluid or a fluid of glucose like compounds.

20. (canceled)

21. A method for storing a medical solution for hemodialysis, hemodiafiltration, hemofiltration, peritoneal dialysis, intensive care fluid management, nutrition compounds concentrates, lavage fluids or for infusion therapies comprising storing the medical solution in the container of claim 1.

22. A system for providing a medical solution comprising at least one container according to claim 1.

23. A system according to claim 22 comprising a water reservoir, a glucose concentrate, at least one electrolyte concentrate and a fluid acid.

24. A system according to claim 22, wherein the concentrates have such pH-values that the resulting medical solution after mixing has a pH-value between 6.5 and 8.0.

25. A method for treatment by hemodialysis, hemodiafiltration, hemofiltration, peritoneal dialysis, intensive care fluid management, nutrition compounds, concentrates, lavage fluids or infusion therapies comprising administering a medical solution from the container according to claim 1.

26. A method of providing an acid diffusion barrier in a container comprising providing as the acid diffusion barrier a polymer comprising at least one cycloolefin polymer and/or at least one cycloolefin copolymer.
